(19) United States
(12) Patent Application Publication
(10) Pub. No.: US 2026/0135358 A1
(43) Pub. Date: May 14, 2026

(54) ELECTRICALLY INSULATED THERMAL SPREADER FOR BUS BARS OF MICROGRID INTERCONNECT DEVICE

(71) Applicant: EATON INTELLIGENT POWER LIMITED, DUBLIN (IE)

(72) Inventors: Mandar Dattatray Mane, Satara (IN); Rohit Kumar Maurya, Varanasi (IN); Avadhoot Kittur, Pune (IN)

(73) Assignee: EATON INTELLIGENT POWER LIMITED, DUBLIN (IE)

(21) Appl. No.: 19/384,121

(22) Filed: Nov. 10, 2025

(30) Foreign Application Priority Data
Nov. 14, 2024 (IN) 202411087950

(51) Int. Cl. H02B 1/56; H02B 1/20

(52) U.S. Cl. CPC H02B 1/56; H02B 1/20

(57) ABSTRACT

A thermal management system is provided for use with an arrangement comprising an MID installed in a meter breaker. The thermal management system comprises a series of aluminum plates having integrated heat spreader pipes. The thermal management system is thermally conductive and electrically insulative, and is structured to be connected between thermal hotspots (evaporator sites) in the MID and meter breaker arrangement and multiple condenser sites in the meter breaker, including the breaker housing and a support bracket. The support bracket can further include fins to provide more efficient cooling.

### CROSS REFERENCE TO RELATED APPLICATIONS

This patent application claims priority to Indian Provisional Patent Application No. 202411087950, filed Nov. 14, 2024 and titled, “Electrically Insulated Thermal Spreader For Bus Bars Of Microgrid Interconnect Device”, the contents of which are incorporated herein by reference.

### FIELD OF THE INVENTION

The disclosed concept relates generally to microgrid interconnection devices (MIDs) used in electrical power distribution systems, and in particular, to thermal management devices and systems for MIDs.

### BACKGROUND OF THE INVENTION

DER (distributed energy resource) systems are relatively small-scale power sources that generate electricity on-site for individual electricity consumers and can be interconnected to the utility electrical grid. DERs enable a consumer to supplement and sometimes replace their use of utility power and can also sometimes supply/backfeed power to the utility grid. A microgrid interconnection device (MID) is a type of switching device used to monitor and manage a microgrid's connection and disconnection between a utility power source and DER systems. MIDs must comply with applicable safety standards such as UL 67, which is directed to service entrance safety requirements.

In order for an MID to receive UL listing, temperature within the MID cannot exceed 65° C. (117° F.) rise over ambient. For at least one known MID designed to be installed in an existing electrical meter breaker, tests show that the electrical terminals of the MID consistently exceed the maximum temperature rise permitted by UL 67 by about 7° C., so a thermal management approach with greater efficacy is needed for use with this MID. Existing methods for hotspot cooling use active cooling methods such as fans for hotspot reduction. However, fans pose reliability challenges and also generate undesirable noise. In addition, a fan cannot be retrofitted into the design of the existing meter breaker.

There is thus room for improvement in MIDs, and in thermal management devices and systems therefor.

### SUMMARY OF THE INVENTION

These needs, and others, are met by embodiments of a thermal management system structured for use with an arrangement comprising an MID installed in a meter breaker. The thermal management system comprises a series of aluminum plates having integrated heat spreader pipes. The thermal management system is thermally conductive and electrically insulative, and is structured to be connected between thermal hotspots (evaporator sites) in the MID and meter breaker arrangement and multiple condenser sites in the meter breaker, including the breaker housing and a support bracket.

In accordance with one aspect of the disclosed concept, a thermal management system is for use with an arrangement comprising an MID installed in a meter breaker having a breaker housing, wherein the meter breaker comprises a support bracket that couples other internal components of the meter breaker to the breaker housing, and wherein the MID is coupled to an electrical bus of the meter breaker. The thermal management system comprises a plurality of thermal conduction plates coupled to one another and structured to be coupled to the electrical bus. The thermal management system is structured to engage the breaker housing and to engage the support bracket. Each thermal conduction plate comprises an aluminum plate having a number of grooves formed therein and a number of heat spreader pipes fixedly coupled to the aluminum plate, with each heat spreader pipe being received within one of the grooves.

In accordance with another aspect of the disclosed concept, an MID and meter breaker arrangement comprises: a meter breaker comprising a breaker housing that houses internal components; a support bracket that couples the internal components to the breaker housing; an MID installed in the meter breaker, the MID being coupled to an electrical bus of the meter breaker; and a thermal management system. The meter breaker is structured to conduct power between a power source and electrical loads. The thermal management system comprises a plurality of thermal conduction plates coupled to one another, coupled to the electrical bus, and coupled to the support bracket. Each thermal conduction plate comprises an aluminum plate having a number of grooves formed therein and a number of heat spreader pipes fixedly coupled to the aluminum plate, with each heat spreader pipe being received within one of the grooves.

### BRIEF DESCRIPTION OF THE DRAWINGS

A full understanding of the invention can be gained from the following description when read in conjunction with the accompanying drawings in which:

FIG. 1 is a view of the front side of an arrangement that includes a known MID installed in a known meter breaker with the housing of the meter breaker removed;

FIG. 2 is a view of the rear side of the arrangement shown in FIG. 1, with the housing of the meter breaker still removed;

FIG. 3 is a perspective view of the rear side of the arrangement shown in FIGS. 1 and 2, shown with the meter breaker housing present;

FIG. 4 is perspective view of the rear side of the arrangement shown in FIGS. 1-3, with a thermal management device in accordance with an example embodiment of the disclosed concept coupled to the arrangement;

FIG. 5 is a perspective view of one example iteration of a thermal conduction plate in accordance with an example embodiment of the disclosed concept, the thermal conduction plate being a component of the thermal management device shown in FIG. 4;

FIG. 6 is a perspective view of an improved support bracket that can be used in the thermal management device shown in FIG. 4 in accordance with an example embodiment of the disclosed concept; and

FIG. 7 is a perspective view of another improved support bracket that can be used in the thermal management device shown in FIG. 4 in accordance with another example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

An innovative thermal management device 100 disclosed herein is advantageously designed to conduct heat away from the hotspots that form when an MID is installed in a meter breaker, at a faster rate than known systems and methods can. Prior to detailing the innovative thermal management device 100, a typical arrangement of a MID installed in a meter breaker will be discussed in order to provide context for the needs addressed by the thermal management device 100.

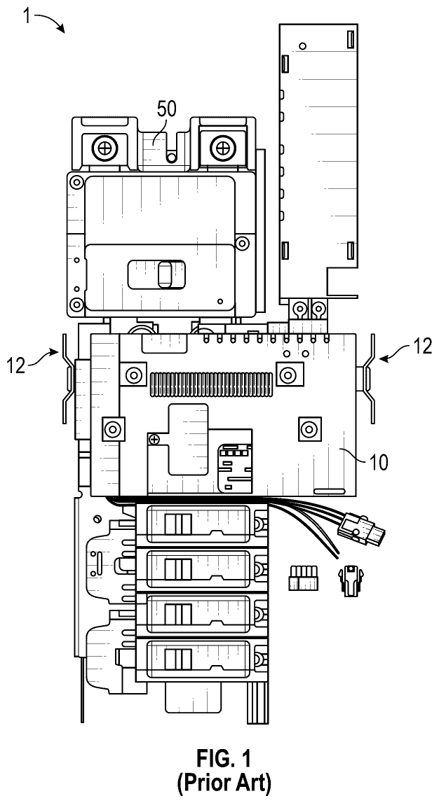

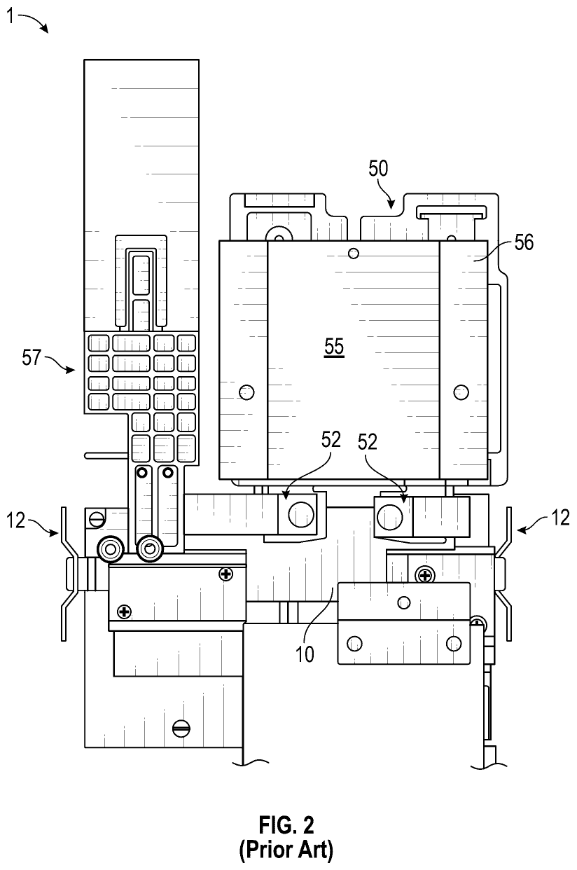

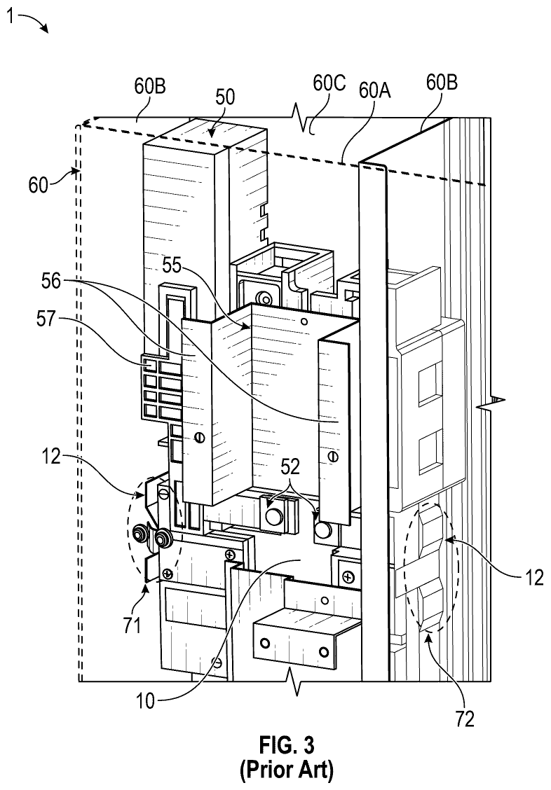

Reference is now made to FIGS. 1-3, which show various views of a known MID and meter breaker arrangement 1 comprising a known MID 10 installed in a known meter breaker 50. The meter breaker 50 comprises a breaker housing 60 (shown only in FIG. 3) that houses the internal components of the meter breaker 50 and houses the MID 10. The term “internal components”, when used herein to refer to the meter breaker 50, refers to the components of the meter breaker 50 housed within the breaker housing 60. Said internal components include the electrical bus 52 of the meter breaker 50, two terminals of which are visible in FIGS. 2-3.

In FIGS. 1 and 2, the breaker housing 60 is hidden so that the MID 10 and internal components of the meter breaker 50 can be viewed more clearly. As shown in FIG. 3, the breaker housing 60 comprises a rear wall 60A, two side walls 60B, and a front cover 60C, with the side walls 60B extending between the rear wall 60A and the front cover 60C. In FIG. 3, the rear wall 60A and one side wall 60B of the breaker housing 60 are both depicted as transparent, so that the spatial relationship between the breaker housing 60, the MID 10, and the internal components of the meter breaker 50 can be seen. The meter breaker 50 comprises a support bracket 55 (shown in FIGS. 2-3) that provides support to the internal components of the meter breaker 50 and couples the internal components to the breaker housing rear wall 60A. In particular, the support bracket 55 comprises a number of wings 56 that engage the rear wall 60A as shown in FIG. 3 and are structured to be coupled to the rear wall 60A (via mechanical fasteners, for example and without limitation).

The terms “rear,” side”, and “front” as used herein to refer to the rear wall 60A, side walls 60B, and front cover 60C are used solely to differentiate the various walls of the breaker housing 60 from one another and should not be construed as limiting on the orientation in which the meter breaker 50 can be used. It is noted, however, that most users of the meter breaker 50 would likely refer to the side of the meter breaker 50 shown in FIG. 1 as the “front” and the side shown in FIGS. 2-3 as the “rear” due to the fact that various switch toggles are located on the side shown in FIG. 1.

In the context of thermal management, an evaporation site is a site from which heat should be conducted away, and a condenser site is a site which heat should be conducted toward. The MID 10 comprises two leaf springs 12 that are connected to the electrical bus 52 in such a manner as to conduct heat away from the electrical bus 52 when the arrangement 1 is providing power to electrical loads, thus resulting in the leaf springs 12 forming hotspots. The leaf springs 12 engage the breaker housing 60 and are the only two sites in the arrangement 1 where the MID 10 forms evaporator sites. In FIG. 3, the two regions where the leaf springs 12 engage with the breaker housing 60 (and specifically with the side walls 60B) are numbered with the reference numbers 71 and 72. The engagement between the leaf springs 12 and the breaker housing 60 in the regions 71, 72 results in the regions 71, 72 being condenser sites on the breaker housing 60. While providing engagement between the MID 10 and the breaker housing 60 in the regions 71, 72 dissipates enough heat to meet the requisite safety standards, such as passing the UL67 test, it is desirable to dissipate the heat significantly further.

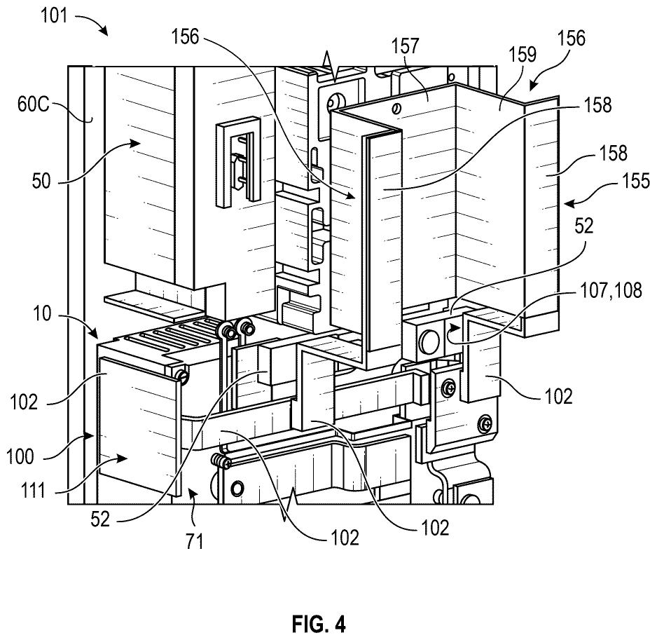

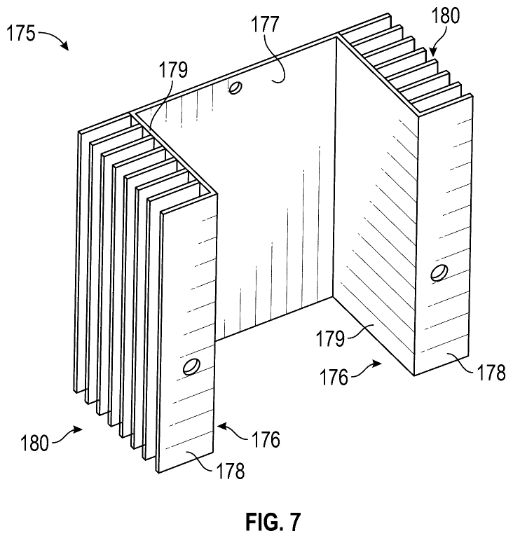

Reference is now made to FIG. 4, which shows the thermal management device 100, in accordance with an example embodiment of the disclosed concept, coupled to the MID and meter breaker arrangement 1 of FIGS. 1-3. It is noted that a removable cover 57 is shown coupled to the meter breaker 50 in FIGS. 2-3, and is omitted from FIG. 4. It is further noted that the breaker housing 60 is omitted from FIG. 4 in order to more clearly show the thermal management device 100, but it should be understood that the breaker housing 60 as shown in FIG. 3 is still a component of the meter breaker 50 shown in FIG. 4. In FIG. 4, the reference number 101 is used to refer to the arrangement of both the MID 10 and the thermal management device 100 being installed in the meter breaker 50, i.e. such that the arrangement 101 is an improved MID and meter breaker arrangement compared to the known arrangement 1 of FIGS. 1-3. As shown in FIG. 4, a bracket 155 resembling the bracket 55 (shown in FIGS. 2-3) is a component of the thermal management device 100 in the improved arrangement 101. While the bracket 155 included in the improved arrangement 101 can comprise the bracket 55 shown in FIGS. 2-3, the bracket 155 can also alternatively take the form of other improved brackets 165 and 175 shown in FIGS. 7 and 8, which are detailed further later herein.

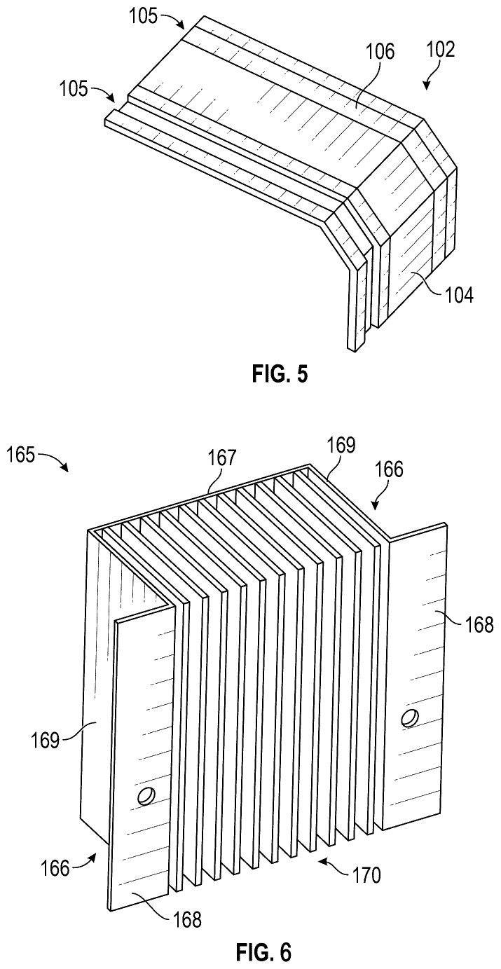

As shown in FIG. 4, the thermal management device 100 comprises a plurality of thermal conduction plates 102 coupled to one another, with one such thermal conduction plate 102 being shown in detail in FIG. 5. It is noted that the thermal conduction plates 102 are shown in simplified form in FIG. 4, such that not all of the structural details shown in FIG. 5 are depicted in FIG. 4. As shown in FIG. 5, each thermal conduction plate 102 comprises an aluminum plate 104 having a number of grooves 105 formed therein. Each groove 105 is structured to receive a heat spreader pipe 106. Each heat spreader pipe 106 is fixedly coupled to the aluminum plate 104 within the corresponding groove 105. The heat spreader pipes 106 can be coupled to the aluminum plate 104 using any of a variety of methods, including for example and without limitation: soldering, mechanical fastening, or epoxy bonding. In the thermal management device 100, every thermal conduction plate 102 comprises the same types of components as every other conduction plate 102, but the dimensions and geometry of each individual thermal conduction plate 102 can differ from the dimensions and geometry of the other thermal conduction plates 102. That is, it should be understood that FIG. 5 is an illustrative example of one of the thermal conduction plates 102, but it should be understood that not every thermal conduction plate 102 in the thermal management device 100 will have the same dimensions and geometry as the specific thermal conduction plate 102 depicted in FIG. 5.

The thermal conduction plates 102 are advantageously designed to optimize both thermal conductivity and structural strength. The heat spreader material from which each heat spreader pipe 106 is produced has high thermal conductivity and relatively low structural strength, while the aluminum from which each aluminum plate 104 is produced has high structural strength and relatively low thermal conductivity. Thus, the thermal conduction plate 102 has high thermal conductivity due to the number of heat spreader pipes 106 and greater structural strength than it would have if it were to be produced only from the heat spreader material. It is noted that heat spreader material is a solid state material that spreads heat over a larger surface area to improve heat transfer. It will be appreciated that the additional heat conduction pathways provided by the thermal conduction plates 102 enable heat to be conducted away from the MID 10 and meter breaker 50 at a much faster rate than is possible in the known arrangement 1.

The thermal management system 100 includes strategic electrical insulation to ensure that the thermal conduction plates 102 are thermally conductive and electrically insulative, so that they conduct heat but do not conduct current, in order to prevent electrical shorting hazards. For example and without limitation, an electrically insulative coating such as epoxy 107 or other thermal interface material can be provided between the thermal conduction plates 102 and the electrical bus 52, and rubber/insulative mechanical fasteners 108 (e.g. bolts, clamps) can be used to mechanically fasten the thermal conduction plates 102 to the electrical bus 52. It is noted that the reference numbers 107 and 108 are used in FIG. 4 to indicate one area where the epoxy and/or mechanical fasteners would be used to couple the thermal conduction plates 102 to the electrical bus 52, but it will be appreciated that no epoxy or mechanical fasteners are visible in the figure.

The spatial relationship between the thermal management device 100, the hotspots in the MID 10, and the breaker housing 60 can be best discerned from viewing FIG. 4 in conjunction with FIG. 3, as the breaker housing 60 is omitted from FIG. 4 in order to better view the internal components of the meter breaker 50. As shown in FIG. 4, the individual thermal conduction plates 102 are coupled to one another and to the electrical bus 52 in a manner that provides a physical link between the thermal hotspots on the electrical bus 52 and both the meter breaker housing 60 and the support bracket 155. As can be appreciated from FIG. 4, the structures of the MID 10 and meter breaker 50 necessitate that some individual thermal conduction plates 102 differ in structure from other individual thermal conduction plates 102.

It will be appreciated from viewing FIG. 4 and from the previous discussion of FIG. 5 that the dimensions and shapes of the thermal conduction plates 102 can vary somewhat from the dimensions shown in FIG. 4 without departing from the scope of the disclosed concept, and that the shape of the overall thermal management device 100 can vary without departing from the scope of the disclosed concept, due to the modular nature of the thermal management device 100. The primary feature of the thermal management device 100 is that it provides a thermal conduction path from the hotspots of the MID 10 to either the breaker housing 60 or the support bracket 155 via the thermal conduction plates 102, which can be achieved with varying combinations and arrangements of the individual thermal conduction plates 102. As such, the exact dimensions and shape of a particular thermal conduction plate 102 depends on the specific area within the meter breaker 50 in which the thermal conduction plate 102 is being installed. For example and without limitation, at least one of the thermal conduction plates 102 shown in FIG. 4 does not include a bend while the thermal conduction plate 102 shown in FIG. 5 does include bends, and the thermal conduction plate 102 shown in FIG. 5 does not include any right angle bends while at least one of the thermal conduction plates 102 includes a right angle bend. However, it should also be understood that, for the specific meter breaker 50 and MID 10 shown in FIG. 4, the dimensions of the thermal management device 100 would not vary widely from those shown in FIG. 4 since the breaker housing 60 poses obvious spatial constraints.

Although the improved MID and meter breaker arrangement 101 is shown in FIG. 4 with the support bracket 155 not having any fins (i.e. resembling the bracket 55 shown in FIGS. 2-3), the support bracket 155 can instead comprise an improved support bracket 165 (FIG. 6) or an improved support bracket 175 (FIG. 7) that includes fins, in order to dissipate heat at an even faster rate, in accordance with additional exemplary embodiments of the disclosed concept. Reference is now made to FIGS. 6 and 7 to discuss the improved support brackets 165 and 175 having fins. Similar to the support bracket 55, the improved support brackets 165, 175 include wings 166, 176 (which are represented by the wings 156 in FIG. 4) and a base portion 167, 177 that is structured to be directly coupled to the other internal components of the meter breaker 50 (the base portions 167, 177 being represented by the base portion 157 in FIG. 4). The wings 166, 176 extend from the base portion 167, 177 in order to engage and be coupled to the breaker housing 60.

Each wing 166, 176 comprises a housing engagement portion 168, 178 that directly engages the breaker housing 60 and an extension portion 169, 179 that extends from the base portion 167, 177 to the housing engagement portion 168, 178. The housing engagement portions 168, 178 and the extension portions 169, 179 are represented by the respective housing engagement portions 158 and extension portions 159 in FIG. 4. The base portion 157, 167, 177, the extension portions 159, 169, 179, and the housing engagement portions 158, 168, 178 are all planar. The extension portions 159, 169, 179 and the base portion 157, 167, 177 are orthogonal to each other. The housing engagement portions 158, 168, 178 and the extension portions 159, 169, 179 are also orthogonal to each other, such that the housing engagement portions 158, 168, 178 are parallel to the base portion 157, 167, 177.

In the support bracket 165 (FIG. 6), the base portion 167 is formed with a plurality of fins 170, with the fins 170 extending from the base portion 167 in the same direction as the extension portions 169 and being parallel to the extension portions 169. In the support bracket 175 (FIG. 7), the extension portions 179 are formed with a plurality of fins 180, with the fins 180 of each extension portion 179 extending from the extension portion 179 in the same direction as the housing engagement portions 178 and being parallel to the housing engagement portions 178. In both of the support brackets 165, 175, the housing engagement portion 168, 178 of each wing 166, 176 provides a suitable surface to which one of the thermal conduction plates 102 can be coupled. This is demonstrated in FIG. 4, wherein both of the wings 156 (corresponding to the wings 166, 176) have a thermal conduction plate 102 coupled to their housing engagement portions 158. This configuration facilitates heat being conducted to the breaker housing 60 as quickly as possible from the housing engagement portion 168, 178 while any heat conducted to the extension portions 169, 179 or base portion 167, 177 will be dissipated by the fins, 170, 180. It will be appreciated that including either of the embodiments 165, 175 of the support bracket 155 having the fins 170, 180 in the thermal management system 100 will increase the thermal dissipation rate of the condenser site as compared to using the support bracket 55.

As indicated in FIG. 4, at least one surface 111 of the thermal management device 100 is structured to engage the breaker housing 60 while other surfaces of the thermal management device 100 are structured to engage the support bracket 155, and more specifically, the wings 156 of the support bracket 155. In comparing FIG. 4 to FIG. 3, it can be discerned that the specific thermal conduction plate 102 comprising the surface 111 that engages the breaker housing 60 (specifically at the side wall 60B) also engages the leaf spring 12 in the region 71. It is noted that coupling the thermal management device 100 to the leaf spring 12 and to the housing 60 in the region 72 is not necessary for the sake of meeting the UL 67 standard (said leaf spring 12 in the region 72 not being visible in FIG. 4), but were a user to desire further heat dissipation, additional thermal conduction plates 102 can be added to extend the length of the thermal management device 100 in order to couple the thermal management device to the leaf spring 12 and housing 60 in the region 72.

As noted in the discussion of FIG. 3, the wings 56 of the support bracket 55 are engaged with the housing 60. In the arrangement 1, the support bracket 55 is not coupled to the bus bar 52 and thus does not conduct heat to the housing 60 in any significant way. However, because the thermal management device 100 couples the support bracket 155 to the bus bar 52 in addition to coupling the support bracket 155 to the breaker housing 60 via the wings 156, heat is conducted to the wings 156 and thus to the breaker housing 60 such that the support bracket 155 serves as an additional structure that dissipates heat in the improved arrangement 101.

Coupling the thermal management device 100 to multiple condenser ends (i.e. both directly to the breaker housing 60 and to the wings 156 of the support bracket 155) and to more condenser ends than in the arrangement 1 has a two-fold advantage: providing more efficient cooling and providing a failsafe. More efficient cooling results from the thermal energy being distributed to more condenser ends in the improved arrangement 101 than in the known arrangement 1. A failsafe is provided, because, in the event that the connection between one of the thermal conduction plates 102 and its intended condenser site (e.g. either the breaker housing 60 or one of the bracket wings 156) fails, the other condenser end(s) can still perform the condenser function of drawing thermal energy away from the evaporation site.

The disclosed thermal management system 100 is advantageous in several respects. The primary advantage that the thermal management system 100 enables the improved MID and meter breaker arrangement 101 to meet the UL67 standard with a significantly wider margin of success than the arrangement 1 can. In addition, it is relatively easy to provide electrical insulation between the thermal management system 100 and the bus bar 52 using epoxy and rubber mechanical fasteners. Due to the compact design of the thermal conduction plates 102, the management system 100 can be easily retrofitted for installation in the arrangement 1 formed when the MID 10 is installed in the existing meter breaker 50, rather than requiring that major changes be made to the design of either the MID 10 or the meter breaker 50. Because the thermal management system 100 does not include any moving parts, there are no noise or reliability issues such as those raised with the use of fans.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A thermal management system for use with an arrangement comprising an MID installed in a meter breaker having a breaker housing, the meter breaker comprising a support bracket that couples other internal components of the meter breaker to the breaker housing, the MID being coupled to an electrical bus of the meter breaker, the thermal management system comprising:
a plurality of thermal conduction plates coupled to one another and structured to be coupled to the electrical bus,
wherein the thermal management system is structured to engage the breaker housing and to engage the support bracket, and
wherein each thermal conduction plate comprises an aluminum plate having a number of grooves formed therein and a number of heat spreader pipes fixedly coupled to the aluminum plate, each heat spreader pipe being received within one of the grooves.

2. The thermal management system of claim 1,
wherein the thermal management system comprises an application of epoxy to render the thermal management system electrically insulative when the thermal management system is coupled to the electrical bus.

3. The thermal management system of claim 2,
wherein the thermal management system is structured to be mechanically coupled to the electrical bus using electrically insulative fasteners.

4. The thermal management system of claim 1,
wherein the thermal management system is structured to be coupled to at least one wing of a number of wings formed on the support bracket.

5. The thermal management system of claim 1, further comprising:
another support bracket, the another support bracket being structured to replace the support bracket, the another support bracket comprising:
a base portion structured to be directly coupled to the other internal components of the meter breaker; and
a number of wings extending from the base portion, each wing comprising:
a housing engagement portion structured to engage and be directly coupled to the breaker housing; and
an extension portion extending from the base portion to the housing engagement portion, the extension portion including a plurality of fins,
wherein the housing engagement portion of at least one wing of the number of wings is coupled to one of the thermal conduction plates.

6. The thermal management system of claim 5,
wherein, for each wing, the fins extend from the extension portion in the same direction as the housing engagement portion and are parallel to the housing engagement portion.

7. The thermal management system of claim 1, further comprising:
another support bracket, the another support bracket being structured to replace the support bracket, the another support bracket comprising:
a base portion structured to be directly coupled to the other internal components of the meter breaker, the base portion including a plurality of fins; and
a number of wings extending from the base portion, each wing comprising:
a housing engagement portion structured to engage and be directly coupled to the breaker housing; and
an extension portion extending from the base portion to the housing engagement portion,
wherein the housing engagement portion of at least one wing of the number of wings is coupled to one of the thermal conduction plates.

8. The thermal management system of claim 7,
wherein, for each wing, the fins extend from the base portion in the same direction as the extension portions and are parallel to the extension portions.

9. An MID and meter breaker arrangement, the MID and meter breaker arrangement comprising:
a meter breaker, the meter breaker comprising a breaker housing that houses internal components, the meter breaker being structured to conduct power between a power source and electrical loads;
a support bracket that couples the internal components to the breaker housing;
an MID installed in the meter breaker, the MID being coupled to an electrical bus of the meter breaker; and
a thermal management system, the thermal management system comprising:
a plurality of thermal conduction plates coupled to one another, coupled to the electrical bus, and coupled to the support bracket,
wherein each thermal conduction plate comprises an aluminum plate having a number of grooves formed therein and a number of heat spreader pipes fixedly coupled to the aluminum plate, each heat spreader pipe being received within one of the grooves.

10. The MID and meter breaker arrangement of claim 9,
wherein the thermal management system comprises an application of epoxy that renders the thermal management system electrically insulative where the thermal management system is coupled to the electrical bus.

11. The MID and meter breaker arrangement of claim 10,
wherein the thermal management system is mechanically coupled to the electrical bus using electrically insulative fasteners.

12. The MID and meter breaker arrangement of claim 9,
wherein the thermal management system is coupled to at least one wing of a number of wings formed on the support bracket, the at least one wing being coupled to the breaker housing.

13. The MID and meter breaker arrangement of claim 9, wherein the support bracket comprises:
a base portion directly coupled to the other internal components of the meter breaker; and
a number of wings extending from the base portion, each wing comprising:
a housing engagement portion structured to engage and be directly coupled to the breaker housing; and
an extension portion extending from the base portion to the housing engagement portion, the extension portion including a number of fins,
wherein the housing engagement portion of at least one wing of the number of wings is coupled to one of the thermal conduction plates.

14. The MID and meter breaker arrangement of claim 13,
wherein, for each wing, the fins extend from the extension portion in the same direction as the housing engagement portion and are parallel to the housing engagement portion.

15. The MID and meter breaker arrangement of claim 9, wherein the support bracket comprises:
a base portion structured to be directly coupled to the other internal components of the meter breaker, the base portion including a plurality of fins; and
a number of wings extending from the base portion, each wing comprising:
a housing engagement portion structured to engage and be directly coupled to the breaker housing; and
an extension portion extending from the base portion to the housing engagement portion,
wherein the housing engagement portion of at least one wing of the number of wings is coupled to one of the thermal conduction plates.

16. The MID and meter breaker arrangement of claim 15,
wherein the fins extend from the base portion in the same direction as the extension portions and are parallel to the extension portions.

17. The MID and meter breaker arrangement of claim 9, wherein the MID comprises:
a number of leaf springs, each leaf spring being connected to the electrical bus in such a manner as to conduct heat away from the electrical bus,
wherein at least one of the thermal conduction plates is coupled to at least one leaf spring of the number of leaf springs.
